(19) United States
(12) Patent Application Publication
(10) Pub. No.: US 2013/0275530 A1
(43) Pub. Date: Oct. 17, 2013

(54) Reduced Latency Messaging For Mobile Communication Devices

(71) Applicant: ZIPIT WIRELESS, INC., Greenville, SC (US)

(72) Inventors: William Matson, Greer, SC (US); Gary Baldwin, Daniel Island, SC (US); Jordan Upham, Pendleton, SC (US); Christopher Ross Squires, Greenville, SC (US); Joseph Ellis, Greenville, SC (US)

(73) Assignee: ZIPIT WIRELESS, INC., Greenville, SC (US)

(21) Appl. No.: 13/862,186

(22) Filed: Apr. 12, 2013

Related U.S. Application Data
(60) Provisional application No. 61/624,055, filed on Apr. 13, 2012.

(51) Int. Cl. H04L 12/58

(52) U.S. Cl. CPC H04L 51/24
USPC 709/206

(57) ABSTRACT

A mobile electronic communication device includes a controller, memory, wireless transceiver, and output device supported by a housing. The controller executes a program with instructions stored in the memory and suspends execution of the program. The controller resumes execution of the program to retrieve a communication message from an online data storage service with the wireless transceiver in response to receiving a notification message with the wireless transceiver. The controller executes the program to retrieve a communication message and outputs the communication message with the output device. The mobile electronic communication device outputs messages with a reduced delay between transmission of the communication message and output of the communication message.

### CLAIM OF PRIORITY

This application claims priority to a U.S. provisional application with Ser. No. 61/624,055, which is entitled “Reduced Latency Messaging For Mobile Communication Devices,” and was filed on Apr. 13, 2012, the contents of which are hereby incorporated in their entirety by reference.

### TECHNICAL FIELD

This document relates to wireless communication systems and, more particularly, to controlling the delivery of communication messages to mobile electronic communication devices.

### BACKGROUND

In recent years, portable electronic devices have gained widespread commercial success. Mobile electronic communication devices (MECDs) include wireless communication devices, typically using one or more forms of wireless data networks, which enable the MECD to remain connected to data networks in many locations. A wide range of handheld MECDs, including so-called “smartphones” and tablet computers with sophisticated software that enable Internet access, text, voice, and video communications, have enabled professionals and other individuals to remain in contact with colleagues and other co-workers.

Mobile electronic communication devices often include powerful electronics including single or multi-core central processing units (CPUs), graphical processing units (GPUs), multi-band wireless transceivers, cameras, speakers, and touchscreen displays in compact packages that are easily carried in a pocket for smartphones or in a small case for tablet computers and devices with larger screens. To enable mobile operation, a battery or other energy storage device is typically housed within the MECD. The size and weight constraints that are present in the compact form factor of an MECD often mean that the battery has a rather small capacity in order to fit within the physical space available in the MECD housing. The MECD is connected to an electrical power source to recharge depleted batteries. While battery storage capacity continues to improve and other energy storage technologies, such as fuel cells, may become common in future MECDs, the components in the MECD also generate heat during operation. Even if the MECD has a long operational battery life, the temperature of the MECD may rise to an unacceptable level when the electronic components in the device operate under heavy loads.

MECDs often include hardware and software that is specifically configured to reduce the power usage of the MECD to maximize the time interval between charges and to maintain the temperature of the MECD at comfortable levels. For example, many MECDs deactivate display screens and other components and operate the CPU in a low-power or “sleep” mode. In the sleep mode, most software activity is suspended and the power consumption of the MECD drops. Some MECD devices also suspend software applications even when the MECD is not in a sleep state. For example, an MECD can suspend “background” email and instant messaging applications while a user is interacting with a “foreground” web browser application. The MECD suspends the background applications to reduce battery consumption and to ensure that more hardware resources are available to the foreground application.

So-called “push” technology also helps to reduce the power usage of an MECD when receiving communications that are sent from third parties through a wireless network. In a “push” scheme, a network service sends messages directly to the MECD to alert the MECD to the presence of a communication message. One commercially available example is the Apple Push Notification Service (APNS), which sends notification messages to certain MECDs to draw the attention of a user to a new communication through audiovisual alerts. The user of the MECD then activates an appropriate software application (colloquially referred to as an “app”) on the MECD to download data from the communication using the wireless networks with the MECD. For example, the APNS system could send a notification to an MECD that the user of the MECD has received new electronic mail messages. The user receives a notification message through an audiovisual and/or haptic alert generated in the MECD, and then activates an electronic mail application that subsequently downloads and displays the new messages.

The push technology can reduce the electrical power consumption of the MECD in some situations because the MECD does not need to initiate communication with an email server or other online service on a regular basis in order to check or “poll” for new communication messages. Since each “poll” requires some CPU usage as well as transmission using the wireless transceiver, the cumulative effect of many “poll” operations can negatively impact battery life. By contrast, the “push” operation reduces the use of the CPU and wireless transceivers in the MECD. For example, the MECD does not need to poll the email server every minute for new email messages when a push alert can signal that new email messages are available instead. Since many MECD users use multiple communication applications including electronic mail, instant messaging, and social networking, the push technology can reduce or eliminate the need to poll many individual services and help to improve battery life.

As described above, sleep modes, including suspended software applications, and push communication help to reduce the power consumption of an MECD. The existing MECD network communication systems are not, however, designed to meet the needs of an alert or paging system that requires rapid and reliable delivery of alert messages to an MECD. Such alert or paging systems are utilized in a wide variety of professions including medical, fire/rescue, police, and building services. Traditionally, specialized hardware, such as pager units and specialized pager transmission networks, have been used to send high priority alerts and messages to one or more pager units. The separate hardware pager is required even though most professionals are already carrying a smartphone, tablet computer, or other MECD because the MECDs do not enable the professional to receive pages and other time-critical communications in a reliable manner. Existing MECDs may either not receive the high priority message at all, or only receive the high priority message after a prolonged delay, which is unacceptable in many professions.

One problem with delivering time-critical messages to an MECD is that existing push technologies rely on a “best effort” approach where a push service attempts to send a push message to an MECD, but does not determine if the MECD actually received the message. If the MECD is in a sleep mode or temporarily disconnected from a wireless data network, then the MECD does not deliver the notification to the user. Even if the MECD receives the push message, a corresponding application that delivers the high priority alerts could be suspended in the background. The MECD does not receive and display the high priority message until the user manually activates the messaging application, which further delays delivery of the message. Consequently, existing communication methods often experience a high latency, or delay, in the delivery of high priority messages to MECDs and in the display of high priority messages to the MECD user.

One solution to reduce communication latency would be to run all applications on the MECD constantly and concurrently to enable message delivery with minimal delay. The battery life and thermal output of the MECD would suffer in such a configuration, however. Consequently, improvements that reduce the latency for delivery of communication messages while enabling the MECD to operate in low power modes would be beneficial.

### SUMMARY

In one embodiment, a mobile electronic communication device that receives high priority messages with reduced latency has been developed. The mobile electronic communication device includes a housing, a wireless transceiver supported by the housing and configured to send and receive data with a wireless communication network, an output device supported by the housing, a memory supported by the housing and configured to store programmed instructions, and a controller supported by the housing and operatively connected to the memory, the output device, and the wireless transceiver. The controller is configured to execute programmed instructions for a messaging program stored in the memory, suspend execution of the programmed instructions for the messaging program, resume execution of the programmed instructions for the messaging program to retrieve a communication message from an online data storage service with the wireless transceiver in response to the wireless transceiver receiving a notification message from a messaging service, the notification message including an identifier corresponding to the messaging program, and generate an output corresponding to the communication message with the output device.

In another embodiment, network communication system that delivers high priority messages to mobile electronic communication devices has been developed. The network communication system includes an online data storage service, a mobile electronic communication device communicatively coupled to the data storage service through a data network, a server executing programmed instructions stored in a memory operatively connected to the server. The server is communicatively connected to the online data storage service and the mobile electronic communication device through the data network. The server is configured to receive a communication message intended for delivery to the mobile electronic communication device, store the communication message in the online data storage service, and send a notification message to the mobile electronic communication device in response to the communication message being stored in the online data storage service.

### BRIEF DESCRIPTION OF THE DRAWINGS

FIG. 1 is a diagram of a messaging system that delivers high priority messages to mobile electronic communication devices.

FIG. 2 is a schematic diagram of a prior art mobile electronic communication device that can be reconfigured to operate with the messaging system of FIG. 1.

FIG. 3A is a depiction of software programs that are executed on a mobile electronic communication device including a messaging application program.

FIG. 3B is a depiction of software programs that are executed on a mobile electronic communication device that is in a low-power operating mode.

FIG. 4 is a block diagram of a process for operating a mobile electronic communication device to receive high priority communication messages with reduced latency.

FIG. 5 is a block diagram of a process for operating a messaging system to send high priority messages to one or more mobile communication devices.

FIG. 6 is a schematic diagram of a system that assigns multiple identities and roles to a mobile electronic communication device to enable communication with different messaging systems.

FIG. 7 is a block diagram of a process for management of an identity and a role for a mobile electronic communication device that communicates with a messaging system.

### DETAILED DESCRIPTION

For the purposes of promoting an understanding of the principles of the embodiments disclosed herein, reference is now made to the drawings and descriptions in the following written specification. The term “mobile electronic communication device” (MECD) refers to any of a number of hand-held or otherwise portable electronic devices that facilitate communication by sending data or voice signals through data networks. Common examples include, but are not limited to, mobile telephones or “smartphones,” tablet computers, personal digital assistants (PDAs), and portable media players that send and receive data using wireless networks.

The term “controller” as used herein refers to an electronic control unit, typically including a microprocessor, but includes any such control capable device such as an ASIC, FPGA, a general purpose CPU, such as a CPU from the ARM family or x86 family, or any data processing device adapted to send and receive data, and to control the operations of the MECD. The controller can also include one or more graphical processing units (GPUs) for driving graphical output through visual display devices. The term “data storage” refers to any device capable of storing and retrieving digital information in a manner that may be used by the controller. Common examples include, but are not limited to, Dynamic Random Access Memory (DRAM), and Static Random Access Memory (SRAM). The term also includes any non-volatile data storage devices that are capable of retaining digital information if electrical power is removed from any of the controller or memory. Such devices include magnetic hard drives, solid-state storage devices including NAND or NOR flash memory, optical data storage devices, or any device capable of retaining digital data in the absence of an electrical power source. The controller operates the MECD in accordance with one or more software programs that are read from a data storage device in the MECD.

As used herein, the term “configure” refers to the arrangement and connection of electronic components in a computing device, including mobile electronic communication devices, together with the storage of programmed instructions and/or parametric data in a computer readable media, such as a volatile or non-volatile memory, hard drive, solid state drive, or the like. The programmed instructions are executed by various processors, including a controller in a mobile electronic communication device, and one or more processors in a server to operate electronic components to perform a function or task. Parametric data, also referred to as configuration data, include any stored data that the programmed instructions reference or otherwise use for computations during performance of the functions and tasks enabled by the configuration of the computing device. Examples include, but are not limited to, user authentication data, directory information, and lists of wireless access points. A configured computing device executes the stored program instructions, and the program instructions may reference stored parametric data during execution of the instructions.

As used herein, the term “identity” refers to a designation that is assigned to one or more registered users of a communication system and stored within a memory of the communication system to manage the sending and receiving of notification and communication messages to the users that are associated with the identity. For example, an identity is stored as a username, employee id number, or other information that identifies a registered user of a system. The identity information optionally identifies the MECD that is used by the registered user with, for example, a hardware specific identifier such as a media access control (MAC) address or cryptographic identification tokens that are stored within a memory of the MECD. In some embodiments, a single MECD is associated with multiple identities in different communication systems. For example, a doctor who works at multiple independent hospitals is assigned separate identities for each of the communication networks that are associated with the hospitals, with a single messaging application in the MECD being configured to communicate with the networks at each of the hospitals. If the doctor stops working at a first hospital, the user account and identity for the doctor at the first hospital can be suspended or deleted while the doctor continues to use the communication system at a second hospital with a second identity without interruption.

As used herein, the term “role” refers to a designation that is assigned to one or more registered users of a communication system and stored within a memory of the communication system to manage the sending and receiving of notification and communication messages to the user identities that are associated with the role. For example, an administrator of a messaging system associates a registered username identity “A” with the role of “ON-CALL PHYSICIAN” during an operational shift at a hospital. Communication messages that are sent to the identity are directed to an MECD that is associated with the user account “A,” even if the sender does not directly address a message to a recipient address that is associated with the user account “A.” The system administrators set the roles for one or more user accounts, and when a role is removed from association with the identity for a particular user, the communication system optionally sends a notification message to the corresponding MECD and the MECD deletes stored communication messages and other data that are associated with the role.

Mobile electronic communication devices typically include wireless transceivers, where a “wireless transceiver” is any device capable of transmitting and receiving information via electromagnetic signals that do not require a physical cable or connection for propagation. Common examples include radio, microwave, infra-red, laser, and optical transceivers. The term “wireless network” as used herein describes any arrangement of two or more electronic devices capable of sending and receiving data where at least one device uses a wireless transceiver to send and receive data. Common examples of wireless technologies often used over broad geographic areas include cellular networks, 3G, 4G, and other wireless wide-area network (WWAN) technologies. Other examples of wireless networks for use within narrower geographic areas include wireless local-area networks (WLAN). WLAN technologies include devices using the IEEE 802.11 series of protocols including “Wi-Fi” branded devices, devices linked via Bluetooth, or devices that exchange information using optical or infra-red signaling.

Various types of messages may be sent using a WWAN or WLAN including “communication messages” and “notification messages.” As used herein, the term “communication message” refers to any form of digital data that can be sent between the MECDs as discrete messages. Communication messages include, but are not limited to, text messages including optional metadata to provide formatting such as font and color metadata, photographs, audio messages, video messages, and numeric pages. Communication messages may also have a variety of metadata, including identification of the sender and recipient of the message, the time when the message was sent and received, priority information, one or more predetermined responses that recipients may send when responding to the message, and status information indicating whether or not the message has been read. Some communication message formats organize message data and metadata into a predetermined structure, including identifying message data and metadata in a structured format such as extensible markup language (XML).

A communication message can optionally include executable program instructions or structured data that are interpreted by a messaging program to perform a predetermined function when the communication message is displayed. For example, a communication message asks for a response and includes structured data with a predetermined list of responses. The MECD displays the message to the recipient and prompts the recipient to enter one of the predetermined responses. The MECD then sends the response to the messaging system for review by the sender and other parties in the messaging system.

As used herein, the term “high priority” communication message refers to a class of communication message where a messaging system minimizes the delay between the sending of the message and the receipt of the message with the receiving device. High priority messages include time-critical content and the value of the message is greatly reduced if a recipient does not receive the message promptly. Additionally, the sender of the high priority message or other users of the messaging system monitor the status of the high priority messages to determine if the message has actually been received by an MECD and if the user of the MECD has responded to the message.

The term “notification message” refers to a message received through a wireless network that alerts the MECD to the presence of communication messages that are stored in an online data storage service. A messaging software application that is executed on the MECD retrieves the communication data promptly after the MECD receives the notification message. The notification message is sent to the MECD from a messaging service using a network protocol that enables the notification message to wake the MECD from a low-power operating mode, commonly referred to as a sleep state, and to resume execution of the messaging application. The messaging application then downloads one or more communication messages from the online data storage service and displays at least one message with minimal delay. The notification messages include any message that is sent through a network using a protocol that is received by the MECD and is passed to a software application that triggers a retrieval operation in the MECD to download and display communication messages with minimal delay. In one embodiment, a notification application runs as a background process whenever the MECD is activated, including when the MECD operates in low power modes. The notification application receives notification messages, wakes the MECD from a sleep state if necessary, and initiates the retrieval and display of communication messages. In another embodiment, the online messaging service sends a session initiation protocol (SIP) message to the MECD. The MECD includes a software service that listens for the SIP message even when the MECD operates in a low-power mode. The SIP message includes a unique identifier that corresponds to the messaging application, and the listener service resumes operations of the suspended messaging application in response to receiving the SIP message.

The terms “gateway” and “portal” as used interchangeably herein to refer to a computing server that is operatively connected to a computing device, often referred to as a “backend” computing device, and to a network. The gateway provides a translation service that enables one or more client computing devices that are operatively connected to the network to access the backend computing device. A web gateway or web portal is an example of a gateway that enables client computing devices to access the backend service using a web browser. Alternative gateways enable clients using different communication methods, such as email, simple messaging service (SMS), secure shell (SSH), telnet, web services, and the like, to access the backend computing device. Gateways and portals may be configured to enable clients to send commands to control the backend computing device, and to receive data from the backend computing device.

The term “delivery receipt message” refers to a message sent from an MECD after successfully retrieving a communication message during operation. The delivery receipt message includes an identifier that associates the delivery receipt message with the original communication message. When a messaging system receives a delivery receipt message from an MECD, the messaging system can display a status indicator to the sender of the communication message or administrator that indicates the MECD has successfully retrieved the message. In one embodiment, the MECD sends the delivery receipt message automatically after retrieving a communication message and before the user of the MECD enters a response to the communication message. Thus, the delivery receipt message can indicate that an MECD has retrieved a communication message, but may not indicate that the user of the MECD has read or taken any other action in response to the communication message.

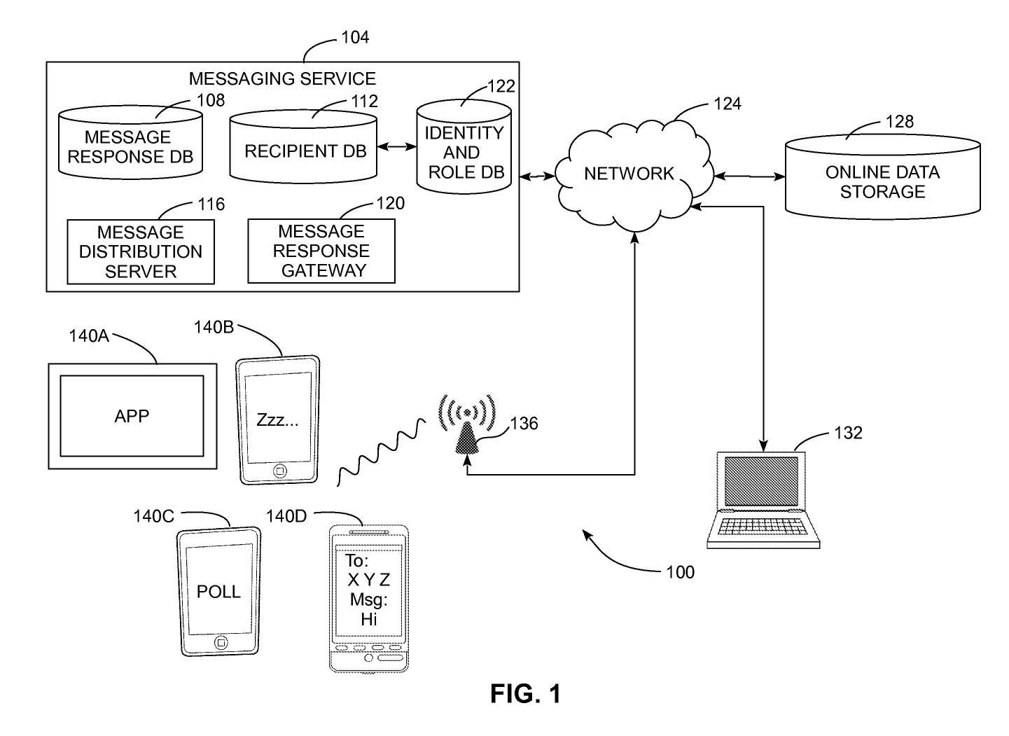

FIG. 1 depicts a messaging system 100 that enables existing MECDs that are reconfigured to execute an improved messaging application program to receive high priority communication messages even when the MECD is in a sleep mode or when the MECD has suspended execution of the messaging application. The messaging system 100 includes a messaging service 104 that communicates with multiple MECDs, which are exemplified by MECDs 140A-140D in FIG. 1. The messaging service 104 and MECDs 140 send and receive data, including communication messages, notification messages, and delivery receipt messages through a data network 124, such as the Internet or other data network. The MECDs 140A-140D are configured to use one or more wireless networks 136. The wireless networks 136 include both WLAN and WWAN networks. Some MECDs include wireless transceivers that access both WLAN and WWAN networks 136, and switch between the networks dynamically during operation.

In FIG. 1, the messaging service 104 includes a message response database 108, recipient database 112, message distribution server 116, message response gateway 120, and a role and identity database 122. The message response database includes information corresponding to the responses received from the MECDs 140A-140D when the MECDs receive a communication message. The recipient database 112 includes registration information corresponding to users of the messaging service 104 and at least one MECD that is registered with each of the users. The recipient database can include authentication credential data to ensure that only registered MECDs can send and receive communication messages in the messaging system 100. The recipient database can also be updated with network addresses, such as internet protocol (IP) addresses, of the MECDs to enable delivery of notification messages to the MECDs. In the messaging service 104, the message response database 108, recipient database 112, and the identity and role database 122 are depicted as separate databases for illustrative purposes, but in alternative embodiments the databases 108, 112, and 122 are organized into a single database with, for example, one or more tables that are indexed for retrieval of data, multiple databases distributed on one or more computing devices, or any other suitable configuration.

The identity and role database 122 includes information about different identities and relationships between the identities and one or more roles that are assigned to registered users. The roles in the identity and role database 122 correspond to single recipient addresses or groups of recipient addresses in the recipient database 112. For example, the identity and role database 122 embodiment of FIG. 1 includes machine-readable and human readable information for the identity and assigned roles of a registered user, including authentication and authorization credentials associated with the identity, and an association between roles and one or more identities for registered users who are assigned to the role. The human readable role identification data include, for example, a text string such as “ON-CALL PHYSICIAN” or other data, such as a graphical symbol, which enables human users to identify the identity during use of the system 100. The authentication and authorization credentials include, for example, public and private keys, passwords, or other credential data that enable the MECDs of users that are assigned to the identity to receive notification messages, retrieve communication messages from the online data storage service 128, and send response messages for communication messages that are sent to the assigned role. During operation, some communication messages are sent to a recipient address corresponding to the role instead of being sent to the addresses that are directly associated with the MECDs of users in the system 100. The messaging service 104 identifies the recipients for a communication that is sent to the role using the identity and role database 122 to identify one or more recipients in the recipient database 112 who correspond to identities that are assigned to the role.

In the messaging service 104, the message distribution service 116 receives incoming communication messages from the MECDs 140A-140D, and from administrators or other users of the messaging service 104 through an administrative terminal 132. In FIG. 1, the MECD 140D is depicted running the messaging application to compose a new message for other MECDs using the messaging system 100, and the messaging terminal 132 can also execute messaging software to compose messages for the MECDs 140A-140D. The message distribution server 116 receives the communication message, identifies network addresses of MECDs corresponding to the recipients, and stores the communication message in the online data storage service 128. The message distribution server 116 sends a notification message to each of the MECDs of the message recipients to alert the MECDs to the presence of a new communication message. The MECDs can send a delivery receipt message to the message distribution server 116 in response to receiving the notification message, and the message distribution server stores the delivery receipt messages in the message response database 108.

The messaging service 104 is communicatively connected to the online data storage service 128 through the data network 124. The message distribution server 116 stores communication messages in the online storage service 128 in association with the recipients of each communication message. While the messaging system 100 includes a separate online storage service 128, another embodiment includes a message storage system that is integrated into the messaging service 104.

In one exemplary embodiment, the data storage service 128 is an online message queue service such as the Amazon Simple Queue Service. The online data storage service 128 is configured to respond to requests for data, including the communication messages, from one or more MECDs. In the messaging system 100, each of the registered users has an individual account in the online storage service 128 for retrieval of communication messages that are sent to each of the users. Once a communication message is successfully retrieved from the message queue, the MECD sends a request to the online data storage service 128 to delete the retrieved message. In the messaging system 100, the messaging service 104 can monitor the number of messages in the queue for each registered user to identify if a communication message has been retrieved. Various alternative embodiments of the online data storage service 128 include electronic mail servers, instant messaging servers, web servers storing communication message data, or any other data storage service that enables the messaging service 104 to store message data for retrieval by the MECDs 140A-140D.

The message response gateway 120 is configured to receive responses from the MECDs 140A-140D after the MECDs retrieve communication messages, and to provide an interface for the sender of the communication message and other users of the messaging system 100 to review responses to the communication message. In one embodiment, the message response gateway 120 includes a server that receives response messages from the MECDs 140A-140D using a structured messaging protocol such as the Extensible Messaging and Presence Protocol (XMPP). The message response gateway 120 stores the response data in the message response database 108 in association with the original communication message associated with the response. The message response gateway 120 can also provide a web server interface to enable the MECDs 140A-140D and the administrative terminal 132 to review the status of responses to communication messages that are stored in the message response database 108. As described in more detail below, the sender or other user of the messaging system 100 can review responses to the communication message, determine if the user of the MECD has received the message but has not responded to the message, or determine if an MECD has likely been unable to receive the communication message.

The messaging service 104 can be implemented using one or more server computing devices. One exemplary configuration includes a server with multiple processing cores, volatile RAM memory and non-volatile storage devices for storing programmed instruction data, a redundant array of independent disks (RAID) to store the data in the message response database 108 and the recipient database 112, and one or more hardware network interface devices to enable the message distribution server 116 and message response gateway 120 to communicate with the online data storage service 128, administrative terminal 132, and with the MECDs 140A-140B. The message response database 108, recipient database 112, and identity database 122 can be implemented using a structured query language (SQL) database, hierarchical database, key-value store, or any other structured data storage arrangement that provides access to the message responses and message recipient information. The message distribution server 116 and message response gateway 120 can be implemented as separate pieces of software executing in one or more computers of the messaging service 104 or a single software program executing on a single computer can implement the functionality of both the message distribution server 116 and message response gateway 120.

The MECDs in FIG. 1 include a variety of different device form factors from different manufacturers and include different types of system software. For example, MECD 140A is a tablet computer, and MECDs 140B-140D are smartphones from different manufactures that can run different mobile operating systems. Each of the MECDs 140A-140D is configured to execute a messaging software application that enables the MECD to receive notification messages and retrieve high priority communication messages. When the messaging system 100 sends a high priority message, the MECDs 140 can be operating in wide range of modes. For example, MECD 140A is running an application program in the foreground and the messaging application is suspended, MECD 140B is in a sleep mode to conserve battery power, MECD 140C is polling the online data storage service 128 to check for new messages, and the MECD 140D is being used to compose a new communication message. As described in more detail below, MECDs 140A-140D are reconfigured for use with the messaging system 100 to activate a messaging application and retrieve the communication message promptly even if the MECDs are in a low-power sleep mode or if the messaging application is suspended.

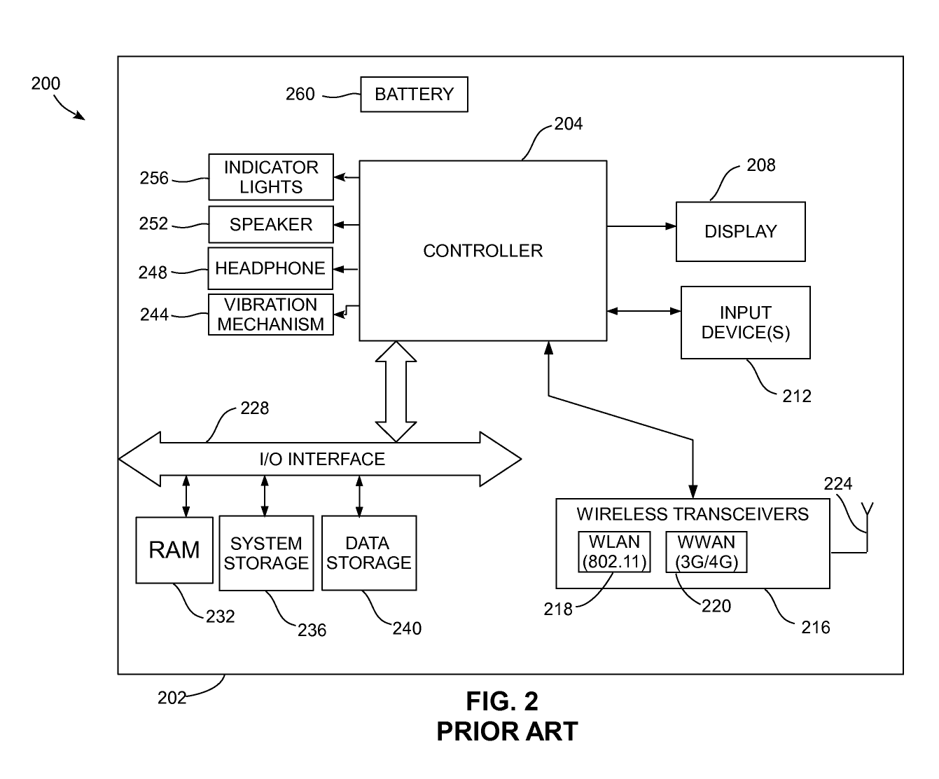

A schematic block diagram of an exemplary prior art MECD 200 is depicted in FIG. 2. The MECD 200 includes components that are commonly used in any of a number of smartphones, PDAs, tablets, and the like. As described in more detail below, the prior art MECD 200 can be reconfigured as described in this document to enable receipt of high priority messages with reduced latency using the online messaging service 100. The components in the MECD are held in a housing 202, which is typically a light weight housing that is held in one or two hands during operation. The components in the MECD 200 consume electrical power during operation, and receive electrical power from a battery 260. The battery 260 is typically a lithium-ion battery or other commercially available battery, but can also be a fuel cell, or any other energy storage device that is suitable for use with the MECD 200.

A controller 204 is communicatively connected to a display 208, one or more input devices 212, one or more wireless transceivers 216, an input/output (I/O) interface 228 for reading and writing data, a speaker 252, headphone jack 248, and vibration mechanism 244. Display 208 is typically a screen small enough to be housed within a hand-held mobile electronic communication device, with common examples using liquid crystal display (LCD) or organic light emitting diode (OLED) panels. Display 208 outputs text and graphics in color as well as monochrome, and can be configured to emit light to make the display contents visible when there is little or no ambient light around the device. Display 208 outputs text or graphical data in response to signals generated by the controller 204.

At least one input device 212 within the MECD 200 permits the user to communicate with and send commands to the controller 204. In one embodiment, the input device 212 includes a touchscreen sensor that is integrated with the display 208. The MECD presents input controls, such as buttons, virtual keys, and other input graphics, on the display 208 and the user touches the surface of the display 208 to input data and select functions through the touchscreen input device. The input device 212 can also include a physical key input such as a numeric keypad or a QWERTY keyboard. Other input devices include touch pads, joystick devices, and trackballs. Still another input device uses a camera to record gestures and other visual information as input. An aural input device may also be used, including a microphone to record spoken commands. Any compatible input device encodes input data in an electronic format capable of being decoded by the controller 204. Various customization settings enable a user of MECD 200 to alter the appearance of messages shown in display 208 and to customize the operation of MECD 200. Such customizations include changing the colors and sizes of fonts for communication messages shown in display 208, selecting themes for various elements of the graphical display, and in selecting alternative alert sounds.

Controller 204 is also connected to a wireless transceiver 216, which is capable of sending and receiving data using one or more wireless signaling protocols and data networks. The wireless transceiver 216 enables the controller 204 to send and receive data over different wireless networks, and to receive command messages sent from another device or server connected to one of the wireless networks.

In various embodiments, an MECD can include two or more wireless transceiver modules, with each module configured to use a separate communication protocol. These protocols may use different operating frequencies and modulation schemes. The wireless transceiver 216 includes one transceiver module 218 that communicates with WLAN networks employing the IEEE 802.11 family of protocols, and another transceiver module 220 that communicates with WWAN networks, such as a 3G or 4G network. Examples of 3G data networks include EvDO and UMTS, while examples of 4G data networks include LTE and WiMAX. Upon establishing a connection with either a WLAN or WWAN, a computer in the network assigns the controller a network address, which is typically an Internet Protocol (IP) address generated with either version 4 (IPv4) or version 6 (IPv6) of the IP standard. Alternative embodiments to wireless transceiver 216 use software-defined radio systems to enable a single physical transceiver to operate with different frequency bands using different signaling protocols. For example, a single physical transceiver executing software with a processor in the transceiver could switch between operation in 802.11 mode or WWAN mode in response to commands sent from the controller 204. The wireless transceiver 216 is electrically connected to an antenna 224. In order to save space in the MECD 200, a single antenna 224 can be configured to be compatible with both the 802.11 transceiver 218 and WWAN transceiver 120. However, alternative devices employ multiple antennas adapted for use with one or more transceivers. Antenna 224 can be replaced by a light-emitter and lenses for alternative transceivers that operate in the infra-red or optical portion of the electromagnetic spectrum.

Continuing to refer to FIG. 2, controller 204 is communicatively coupled to a data input-output (I/O) interface 228. In MECD 200, the I/O interface 228 is a shared electronic bus that operationally connects controller 204 to random access memory (RAM) 232, a data storage device holding operating software 236, and a digital storage device holding message and user data 240. Alternative I/O interfaces include point-to-point or switched I/O schemes to facilitate communication between controller 204 and one or more memory and storage devices. RAM 232 holds command instructions and operating data used by controller 204 during normal operations. RAM 232 is typically volatile, meaning that when electrical power is removed from the device, the contents of data held in the RAM are erased. System storage 236 holds the stored machine readable instructions for one or more programs that the controller 204 reads to receive instructions that are used to implement various operations of MECD 200. In some embodiments, system storage 236 also holds operating instructions used to configure other system components including the wireless transceiver 216. The system storage 236 is typically stored in a non-volatile storage device, such as a NAND or NOR flash device, to enable the instruction codes held in system storage 236 to be re-read after electrical power is removed from the MECD 200. The data contents of system storage 236 may be referred to as “firmware” because they are not supposed to be altered during normal operation, but can be updated periodically to allow for updates to the operating commands used in the MECD 200.

Data storage device 240 stores sent and received communication messages and other user information used by MECD 200. User information includes user customization settings that are stored in an XML data record format in the embodiment of FIG. 2. Data storage device 240 allows for access to previously received communication messages without the need to retransmit those messages over a wireless network. Like system storage device 236, data storage device 240 is typically a non-volatile device for the long-term retention of user data. However, the data storage 240 is configured to have stored data read, written, and erased by controller 204 during normal use of the MECD 200. The data storage device 240 and system storage device 236 are optionally placed in logically separated areas of a single physical device.

Controller 204 is optionally connected to one or more audio, visual, or vibrational indicator devices. These devices emit sounds, produce vibrations, and provide visual cues providing feedback to the user about the status of the device. Audio outputs, which include a built-in speaker 252 and head phone output 248, can provide audible alerts when a new message is received, and can be configured to play back audio messages. Audio outputs have an adjustable volume level that can be changed in response to control signals sent by controller 204. A vibration mechanism 244 vibrates in addition to, or instead of, an audible alert sounding in some configurations. Common vibrational mechanisms employ a small electrical motor with a rotating axle connected to a weight that is shifted off-center of the rotational axis of the axle. One or more indicator lights 256 can also activate or blink in a pattern to communicate device status and indicate the arrival of a communication message. Multiple lights having different colors can also be used to provide more information. For example, a red light can indicate receipt of a high priority message, while a green light can indicate that a low priority message has been received.

While FIG. 2 depicts functional components of an MECD, various alternative MECD configurations can be used to send and receive high priority messages through wireless data networks. Some of the components in the MECD, including the controller 204, wireless transceiver 216, RAM 232, system storage 236, and data storage 240, are integrated into a system on a chip (SoC) device.

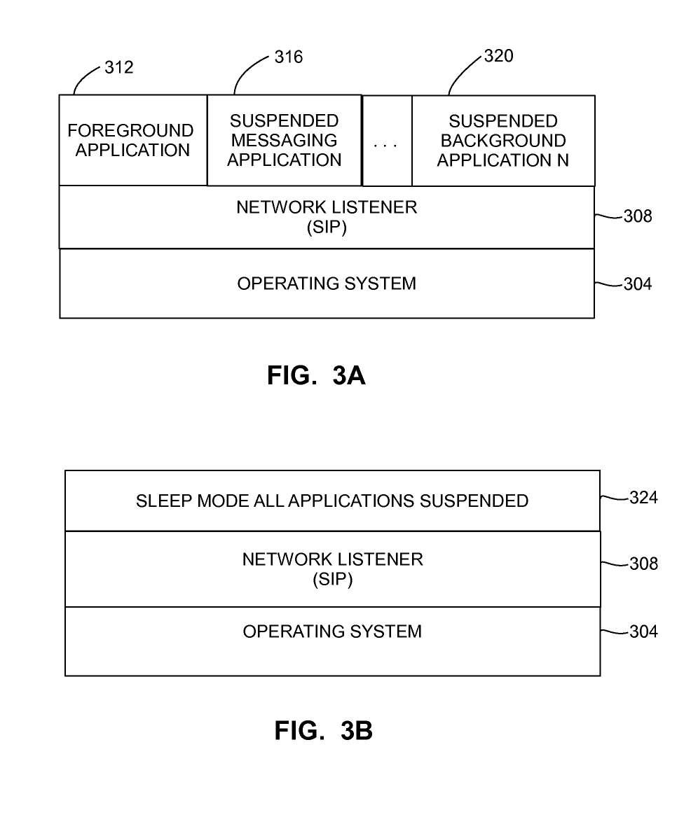

FIG. 3A is a representation of MECD operation arising from the execution of software by a processor in an MECD, such as the MECD 200 of FIG. 2, when a foreground software application is activated. FIG. 3A depicts an operating system (OS) 304, a network listener service 308, a foreground application 312, a suspended messaging background application 316, and optional suspended background applications 320. The operating system (OS) layer 304 supervises the execution of application level programs and provides software interfaces to various hardware components in the MECD 200 through device drivers. The controller 204 and other hardware components in the MECD 200 perform operations in response to the software instructions in the operating system 304. For example, the operating system implements a network stack using a combination of hardware and software to control sending and receiving of data packets with the wireless transceiver 216. One example of a network stack implements a version of the Internet Protocol (IP) and the transmission control protocol (TCP) or user datagram protocol (UDP). The network stack enables the MECD to process data packets corresponding to SIP messages and to other protocols used by the MECD. In some MECD devices that implement software-defined radios, the operating system layer 304 also implements some of the functionality of the wireless transceiver 216 as software instructions executed by the controller 204. The OS 304 controls the function of other software applications that are executed on the MECD and acts as an intermediary between the applications and the hardware in the MECD to ensure reliable and secure operation of the MECD. Examples of operating systems that are used in existing MECD devices include Linux and Linux derivatives, such as Android, Apple iOS, mobile variants of Microsoft Windows, and any other operating system that is suited for use on an MECD.

The network listener service 308 is a background service, sometimes referred to as a daemon, which is executed when the MECD 200 is activated in response to the MECD accessing a wireless data network. In some embodiments, the network listener service 308 is implemented as part of the OS 304, while in other embodiments the operating system 304 executes the network listener service 308 automatically when the MECD is activated. In the MECD 200, the network listener service 308 listens for SIP messages in incoming messages that are received with the wireless transceiver 216. As used herein, the term “listen” when applied to a software application means that the software application processes incoming data packets until identifying a message having one or more network packets that form a SIP message that includes predetermined parameters. For example, the network listener service 308 can open a network socket in conjunction with the network stack in the OS 304 using a port number corresponding to the SIP protocol, such as port 5060 for TCP SIP messages and port 5061 for UDP SIP messages, and identify a SIP invitation message that corresponds to the suspended messaging background application 316.

The foreground application 312 is a software application that a user of the MECD runs manually and controls through one or more input and output devices in the MECD. The foreground application can be any of a wide range of software programs that are executed in the MECD including web browsers, media applications, communication applications, games, mapping and navigation applications, utilities and the like. The user of the MECD directly interacts with the foreground application 312, and the foreground application 312 typically generates a visual or audible output. The foreground application 312 performs operations that interact with services provided through the OS 304. For example, the foreground application 312 reads and writes data from memory and files in non-volatile data storage devices, displays graphics, and sends and receives data using the wireless transceiver by accessing software interfaces provided by the OS 304.

While executing the foreground application, one or more background software applications 320 are suspended. Program data corresponding to the suspended applications are still stored in the memory of the MECD, but the OS 304 prevents the suspended applications from using appreciable amounts of resources in the MECD to favor execution of the foreground application 312. The user of the MECD switches between running applications manually, and one of the suspended applications 320 can become the foreground application 312, while the prior foreground application 312 is suspended.

In FIG. 3A, one of the suspended background applications is the messaging application 316. The messaging application 316 registers with the network listener service 308 in association with a parameter in an incoming SIP message that corresponds to the messaging service 104. For example, the header of each SIP message contains a uniform resource identifier (URI) string corresponding to the sender of the SIP message. The messaging application 316 registers the URI with the network listener service 308, and when the network listener service 308 receives a SIP message with the corresponding URI, the network listener service 308 resumes operation of the messaging application 316, even if another application 312 is in the foreground.

FIG. 3B is a representation of software that is executed on an MECD, such as the MECD 200 of FIG. 2, when the MECD operates in a low-power “sleep” mode. In the low-power mode, the operating system 304 deactivates various components in the MECD, such as the GPU in the controller 204 and display 208, and operates other components, such as the CPU in the controller 204 and wireless transceiver 216, in reduced power modes. The operating system 304 continues to execute, but may optionally suspend some operations when the MECD is in the low-power mode to reduce power usage. The network listener service 308 continues to run to listen for incoming SIP messages that are received through the wireless transceiver 216.

When the wireless transceiver 216 receives a SIP message through a wireless network, the network listener service 308 identifies whether the SIP message corresponds to the messaging application 316. The wireless transceiver 216 can receive multiple data messages corresponding to various protocols and can also receive SIP messages that are not intended for the messaging application. If the network listener service 308 identifies the SIP message as being directed to the messaging application 316, then the network listener service 308 generates a request for the OS 304 to wake the MECD from the sleep state. The OS 304 wakes the MECD from the sleep state and activates the messaging application 316 if the messaging application 316 was previously suspended. The messaging application 316 subsequently downloads one or more communication messages, and the MECD displays the messages and alerts the user to the new messages.

While FIG. 3A and FIG. 3B depict two operating modes of an MECD, some MECD embodiments include a plurality of operating modes to control the consumption of power. For example, in one alternative configuration, the MECD returns from the sleep mode of FIG. 3B to an intermediate operating mode to activate the messaging application 316 and retrieve communication messages. The output devices of the MECD are not activated until after the MECD generates an audible alarm and the user manually activates the display to view the messages.

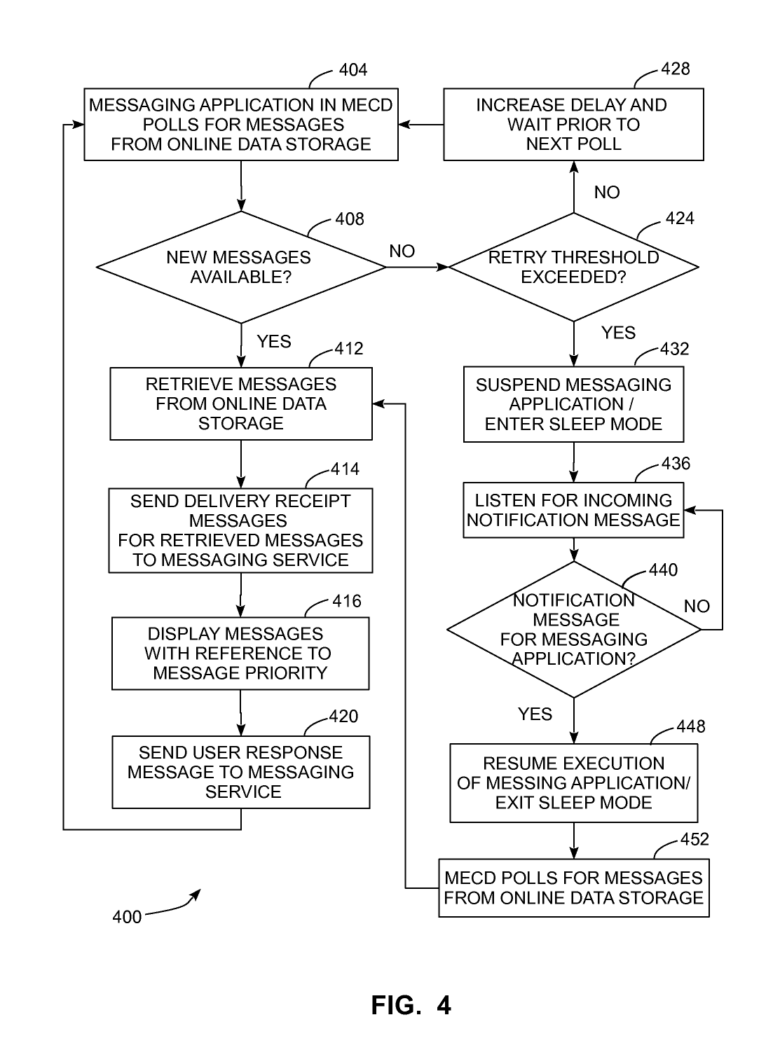

FIG. 4 depicts a process 400 for operating an MECD, such as one of the MECDs 140A-140D, to receive high priority messages from a messaging service while also operating in low power modes to improve battery life. In the discussion below, a reference to the process performing a function or action refers to a controller, such as the controller 204 in the MECD 200, executing programmed instructions stored in a memory to operate one or more components to perform the function or action. Process 400 is described with reference to the messaging system 100 of FIG. 1 and the MECD 200 of FIG. 2 for illustrative purposes.

Process 400 begins when a messaging application that is executing in an MECD polls an online data storage service for new communication messages (block 404). In the MECD 200, the messaging application is configured to poll for new messages when the controller 204 begins execution of the messaging application. The messaging application polls for messages that are directed to the MECD 200 when the MECD 200 is activated or connects to a wireless data network after being disconnected. If new messages are available (block 408), then the MECD 200 proceeds to retrieve the messages from the online data storage service (block 412). In the example of FIG. 1, the MECD downloads the communication data from the online data storage service 128 using an appropriate protocol. The MECD can optionally send a delete message to the online data storage service 128 to delete communication messages after successfully retrieving the messages. Either or both of the communication channels between the MECD 200 and the online data storage service 128 and the contents of the communication messages can be encrypted to prevent eavesdropping on the contents of the communication messages.

Once the communication messages are retrieved, the MECD sends one or more delivery receipt messages to the messaging service to confirm that the MECD has received the communication messages (block 414). The MECD sends the delivery receipt message to the message distribution server 116 in the messaging service 104 automatically once the communication message is successfully retrieved. The delivery receipt message is sent to indicate that the MECD has successfully downloaded a communication message, but does not necessarily indicate that a user of the MECD has acknowledged and responded to the message.

A delivery receipt message includes an identifier corresponding to the retrieved communication message. For example, each communication message can include a unique identifier number that is copied in the delivery receipt messages to enable the messaging service 104 to associate the delivery receipt message with the communication message. In another configuration, the messaging service 104 and the recipient MECDs both generate a numeric hash value corresponding to the contents of the communication message. The messaging service 104 stores the hash value in the message response database 108 and the delivery receipt message includes the same hash value to indicate successful delivery of the communication message to the MECD. In one configuration, the MECD generates and sends a delivery response message for each of the delivered communication messages. In another configuration, the MECD sends a single delivery receipt message that includes identifiers for multiple communication messages. When the MECD retrieves multiple communication messages from the online storage service 128 in a short time period, a single delivery receipt message can include identifiers for each of the communication messages.

The MECD displays one or more of the retrieved communication messages with reference to a priority assigned to each message (block 416). The metadata of each communication message include an assigned priority value, which can be a text value, numeric value, or any other value that indicates the importance of the communication message. For example, messages can have “low,” “normal,” and “high” priorities. The messaging application on the MECD controls the display of messages based on the priority level. One configuration displays a low priority message as part of a list of messages when the user manually selects the messaging application and views messages. The MECD displays a notification or generates a single audible alert in response to receiving a normal priority message to alert the user of the presence of the new message. The user then activates the MECD application to view the message. When the MECD receives a high priority, the MECD immediately activates the messaging application and displays the high priority message, even if the user was using a different foreground application when the message was received. Additionally, the MECD can activate audible and vibrational alarms continuously to alert the user to the high priority message.

In process 400, when the MECD downloads multiple messages of different priority levels, the messaging application selects an output based on message priority. For example, if the messaging application downloads two low priority messages and subsequently downloads a high priority message, the display of the high priority message preempts the display of the low priority messages until the user enters a response to the high priority message.

After retrieving the communication messages, the MECD sends a response message to the messaging service (block 420). In the messaging system 100, the MECD 140A-140D that retrieved the communication messages from the online data storage service 128 sends an response message to the messaging service 104. The response message can include different response data based on the content of the original communication message. For example, a response message can simply acknowledge that the MECD retrieved the communication message and that the user of the MECD pressed an on-screen button or took some other action to acknowledge receipt of the message. Other communication messages present questions to the user, such as yes or no questions or multiple-choice responses to questions, in the communication message. The response message includes the answer that the user enters to the question. The messaging service 104 stores the response messages in the response message database 108 in association with the original communication message. Administrators of the messaging service and the party who sent the communication message review responses from the recipients of the messages via the message response gateway 120.

In process 400, the MECD can poll the online data storage service, but receive no new communication messages (block 408). The messaging application delays a subsequent poll of the messaging service when no messages are present. The MECD continues to poll at increasing intervals while the number of polls is below a predetermined retry threshold (block 424). For each subsequent poll, the messaging application increases the delay prior and waits to polling the online data storage service for new messages (block 428). For example, in one configuration the messaging application waits for fifteen seconds prior to polling the online data storage service 128 when no new communication message is available. The delay increases to thirty seconds if no new communication messages are available after the second poll request. The delay doubles between each subsequent poll request until the retry threshold in block 424 is exceeded.

Once the retry threshold is exceeded (block 424) the messaging application suspends polling of the online data storage service (block 428). Since polling the online messaging service uses both CPU resources and the wireless transceiver, the messaging application suspends the polling process to reduce the power consumption of the MECD. The OS in the MECD can also suspend the messaging application while the user runs other foreground applications or enter a sleep mode to further reduce power consumption.

As depicted in FIG. 3A and FIG. 3B, the network listener service 308 continues to listen for incoming notification messages, such as SIP invite messages, from the messaging service 104 that indicate new communication messages are available in the online data storage service 128. In process 400, the MECD suspends the polling operation of the messaging application and listens for incoming SIP messages (block 436) until the network listener service receives the appropriate SIP message (block 440). Once the notification message is received, the MECD OS resumes operation of the messaging application (block 448) and the MECD polls the online data storage service 128 for the new communication messages (block 452). Process 400 subsequently returns to block 412 to retrieve and display the new messages as described above.

In process 400, an MECD uses a polling technique to retrieve communication message data, but ceases polling when new communication messages are not available to reduce the power usage of the MECD. In a traditional MECD, a messaging application has to either continuously poll for additional messages, which consumes additional power, or the application has to wait for a user to poll for the new messages manually, which can result in long delays before the user receives high priority messages. Existing “push” notification services, such as APNS, only generate an onscreen display requesting that a user manually activate the messaging application manually to poll for new messages. The push notification delivery is often unreliable when the MECD is in a sleep state, while the notification messages described in process 400 are delivered reliably even when the MECD operates in a low power mode. Consequently, process 400 enables an MECD to receive high priority communication messages with minimal delay while also enabling the MECD to operate in low power modes to increase battery life.

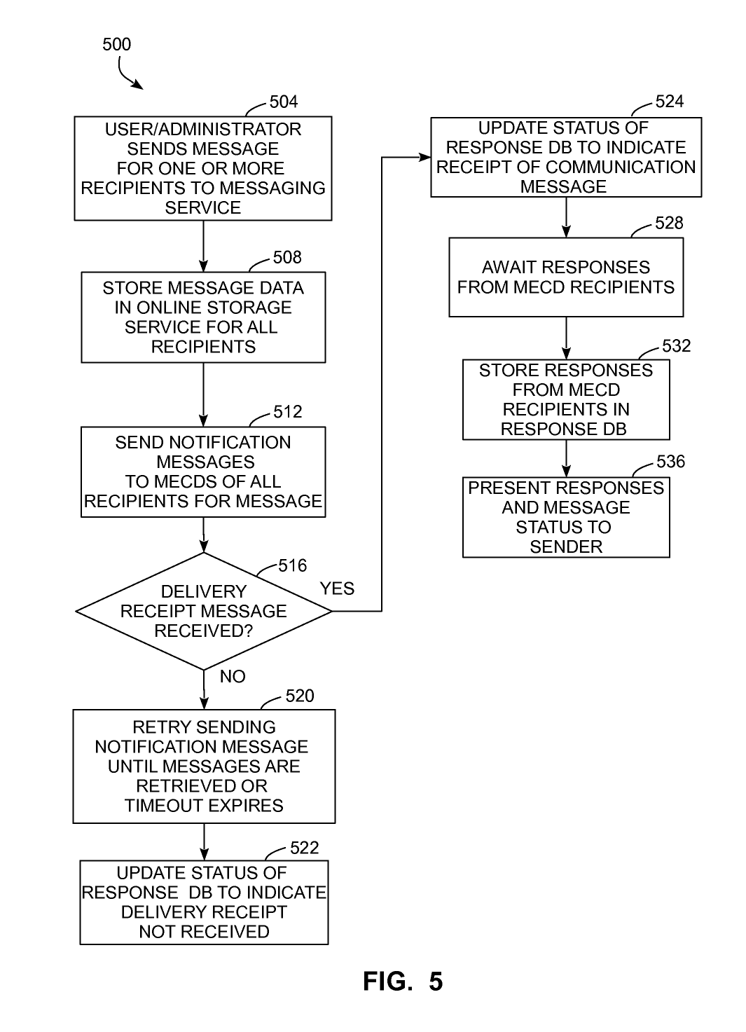

Process 400 describes the operation of an MECD in the messaging system 100. FIG. 5 depicts a process 500 for operation of a messaging service in conjunction with the MECD to enable delivery of time-critical messages to the MECD. In the discussion below, a reference to the process performing a function or action refers to a controller or processor, such as one or more processors in the messaging service 104, executing programmed instructions stored in a memory to operate one or more components to perform the function or action. Process 500 is described with reference to the messaging system 100 of FIG. 1 and the MECD 200 of FIG. 2 for illustrative purposes.

Process 500 begins when a user or administrator of the messaging system 100 sends a communication message that is intended for one or more recipients (block 504). In the system 100, a user generates new communication messages using the messaging application in the MECD. For example, FIG. 1 depicts the MECD 140D with an interface that enables the user to select recipients for a message and to enter a message. The recipient list can include identifiers of individual recipients, and identifiers of predetermined groups of recipients that the messaging service 104 stores in the recipient database 112. The message can include text, graphics, audio, and video. Additionally, the message can include automated responses for the recipients. For example, a meeting announcement message prompts the recipients to respond with a “yes” or “no” as to whether the recipient will attend the meeting. A sender, such as an administrator who does not use an MECD, can also send communication messages using a computer terminal 132. The communication message and list of recipients is sent from the MECD 140D or computing terminal 132 to the messaging service 104 through a data network such as the data network 124.

The messaging service 104 receives the message and stores the content of the message in an online storage service that is accessible to the MECDs of the recipients (block 508). In the messaging system 100, the messaging service 104 forwards the communication message to the online data storage service 128. In the configuration of FIG. 1, the online data storage service 128 is a separate data service from the messaging service 104. In one embodiment, each of the recipients of the message has a previously configured account with the online data storage service 128. The message distribution server 116 in the messaging service 104 copies the communication message into a message queue or other data storage account for each of the message recipients.

In process 500, the messages that are stored in the online data storage service 128 are available for retrieval by the MECDs 140A-140D. An MECD that is actively polling the online data storage service 128, such as the MECD 140C, retrieves and displays a new message when the new message becomes available. Other MECD devices, such as MECDs 140A and 140B, are either running another foreground application or are in a sleep mode where the messaging application is suspended. To ensure that the MECD corresponding to each of the recipients retrieves the stored communication messages promptly, the message distribution server 116 sends a notification message to the MECD for each of the message recipients (block 512).

As described above, one type of notification message is a SIP message, such as a SIP invite message. The message distribution server 116 identifies a network address, such as an IP address, for each of the MECDs with reference to address information stored in the recipient database 112 or with reference to a name service, such as a mobile domain name service (DNS) for MECD devices that change network addresses frequently during operation. An MECD that receives the notification message resumes operation from a sleep mode or activates a suspended messaging application to retrieve the communication message promptly as described in process 400. The MECD sends a delivery receipt message to the message distribution server 116 in response to successfully retrieving the communication message.

If the message distribution server 116 does not receive a delivery receipt message after a predetermined timeout period (block 516), then the message distribution server 116 can re-send the notification message (block 520). For a high priority message, the distribution server 116 sends notification messages to the MECD at regular intervals until the MECD successfully retrieves the communication message or until a timestamp associated with the communication message expires. For example, a high priority communication message can have an expiration time of one hour after the initial transmission of the communication message. The message distribution server 116 sends notification messages to the MECD until the expiration of the one hour time period if the MECD does not retrieve the communication message. For example, the distribution server 116 sends the notification message at thirty-second intervals until the MECD receives the notification message and successfully transmits the delivery receipt message to the message distribution server 116 to indicate successful delivery of the notification. In another embodiment, the message distribution server 116 sends notification messages at an increasing frequency until the receipt message is received from the MECD. In one embodiment, the message distribution server 116 sends a first notification message and waits for a predetermined timeout of three hundred seconds. If the receipt message is not received prior to expiration of the first timeout, then the message distribution server 116 sends a second notification message with a shorter timeout of, for example, one hundred fifty seconds. The message distribution server 116 sends additional notification messages at progressively shorter intervals until the distribution server 116 reaches a predetermined minimum interval (e.g. 18.75 seconds) and continues to send the notification messages at the predetermined minimum interval. The message distribution server 116 continues sending the notification messages until the MECD responds with a delivery receipt message to one of the notification messages, or until a maximum number of notification messages are sent and the messaging service 104 identifies a failure in the message delivery. For a low priority message, the message distribution server 116 can be configured to send only one notification message to the MECD. The MECD retrieves the low priority message promptly if the MECD is activated and connected to the wireless network 136, but the MECD can also retrieve the low priority message at a later time if the MECD fails to receive the notification message.

In the system 100, the messaging service 104 transmits the notification messages in a repeated manner until receiving the delivery receipt message from the MECD that is specified in the notification message. The notification messages are typically sent using network protocols that do not guarantee receipt of the notification message and do not provide direct feedback to the messaging service 104 to indicate failed delivery. For example, the message distribution server 116 does not receive a direct confirmation that the MECD receives the SIP invitation message. Retransmission of the notification messages upon the expiration of the timeout enables the messaging service 104 to provide more reliable delivery of the communication messages or to alert an administrator or other users of the system 100 if an MECD is unable to receive the notification messages for a prolonged period of time.

In the messaging system 100, the messaging service 104 can optionally check the status of communication messages in the online data storage service 128. The communication messages are deleted when an MECD successfully retrieves the message. Consequently, if a communication message has been deleted from the online data storage service then the messaging service 104 can update the message response database 108 to indicate delivery of the communication message even if the messaging service 104 did not receive the delivery receipt message due to, for example, an intermittent network outage between the messaging service 104 and one or more of the MECDs 140A-140D. In another embodiment, the MECD sends the delivery receipt message after the successful retrieval of the communication message from the online data storage service 128 instead of immediately after receiving the notification message. The receipt message optionally includes a message digest or other identification data that identify the retrieved communication messages in the receipt message.

After one or more transmissions of the notification message without a delivery receipt message being received from the MECD, the message distribution server 116 updates the message response database 108 to indicate that the MECD has not sent a delivery receipt message (block 522). For example, if the MECD is deactivated or outside of the range of any wireless network, the messaging service updates the response database to inform the sender that the recipient is most likely unable to receive the communication message.

If the MECD retrieves the communication message and sends an appropriate delivery receipt message to the messaging service 104, the message distribution server 116 updates the message response database 108 to indicate successful delivery of the communication message (block 524). After generating notifications for the MECDs of the message recipients, the messaging service 104 waits for responses from the recipients (block 528). The MECDs retrieve the communication message from the online data service 128 and display the message to the recipient users as described above with reference to process 400. The users enter any responses that are requested in the communication message and the MECDs send the response messages to the message response gateway 120. The message response gateway 120 stores the responses in the message response database (block 532).

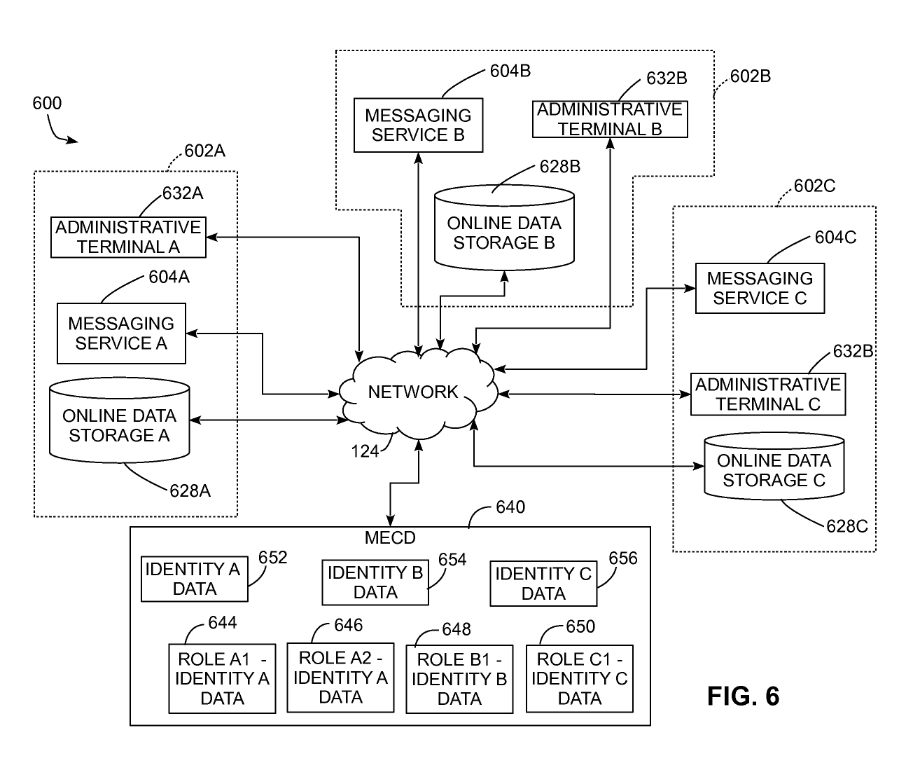

As the messaging service 104 receives responses to the communication message, the message response gateway 120 presents the content of responses and the status of recipients to the sender (block 536). In one configuration, the message response gateway 120 includes a web server that presents the responses to the communication message to the sender as a web page. In another embodiment, the message response gateway 120 forwards the responses to the online data storage service 128 in an account corresponding to the MECD that sent the communication message. The responses and the status of responses are updated dynamically as users respond to the communication message. The sender can identify MECDs that did not retrieve the communication message and send delivery receipt messages, which may indicate that the MECDs are temporarily unable to receive the communication message. The sender or administrator can also identify MECDs that did retrieve the communication message and sent receipt messages, but where MECD users have not yet responded to the communication message. Consequently, process 500 enables the sender to verify that recipients of a communication message either have received the communication message or have not received the communication message, and to review responses to the communication message. FIG. 6 depicts a communication system 600 that includes three independent messaging systems 602A, 602B, and 602C that are each configured to send and receive messages with a single MECD 640. In the system 600, the messaging system 602A includes one or more computing devices that implement a messaging service 604A, online data storage service 628A, and an administrative terminal 632A that are communicatively coupled to the MECD 640 through the network 124. The messaging service 604A, online data storage service 628A, and administrative terminal 632A are each configured in the same manner as described above with reference to the messaging service 104, online data storage service 128, and administrative terminal 132, respectively, in the system 100.

In FIG. 6, the MECD 640 is a smartphone, tablet, PDA, or other portable electronic device as depicted above in the system 100. In the configuration of FIG. 6, the MECD 640 is configured to receive notification messages, retrieve communication messages, and send communication messages with multiple identities 652, 654, and 656 that are assigned to the user of the MECD 640. In the example of FIG. 6, the user is assigned identity “A” 652 for the communication system 602A, identity “B” 654 for the communication system 602B, and identity “C” for the communication system 602C. The identity data 652-656 include authentication information that are used to retrieve communication messages that are directed to recipient addresses associated with the registered user in the communication systems 602A-602C, respectively. In the MECD 640, the data storage memory 240 also stores data corresponding to relationships between roles and identities 644, 646, 648, and 650. Each set of role-identity data includes notification and communication messages that are sent to the MECD in conjunction with the corresponding role. In some embodiments, the role-identity data include additional authentication information to enable the MECD 640 to retrieve communication messages that are sent to the assigned role in addition to the authentication information for the identity of the registered user. The role data optionally include address book data that include contact information for other users that are assigned to the same role to enable the user of the MECD 640 to send messages to the MECDs of other users who share the same role.

Each identity corresponds to a single one of the independent communication systems 602A-602B, although a single user is optionally assigned multiple identities in a single communication system. For example, the MECD 640 in FIG. 6 is depicted with two user role-identity relationships 644 and 646. Both of the role-identity relationships 644 and 646 denote the identity “A” 652 that is registered with the communication system 602A. The role and identity data sets 644 and 646 further includes roles denoted “A1” and “A2,” respectively, which correspond to different roles for the user identity “A” in the communication system 602A. While not depicted expressly in FIG. 6, a single user is optionally assigned multiple identities for a single communication system. For example, the user of the MECD 640 is assigned an identity corresponding to a standard user of the communication 602A and another identity corresponding to an administrator of the communication system 602A. The user performs separate authentication operations to access the communication system 602A using either of the two identities. The role-identity data 648 corresponds to an identity “B” and role “B1” that are associated with the communication system 608B, and the role-identity data 650 correspond to an identity “C” and role “C1” that are associated with the communication system 608C.

During operation, administrators in each of the communication systems 602A-602C assign identities and roles to the user of the MECD 640. For example, in the communication system 602A the administrator uses the administrative terminal 632A to update the recipient database 112 and identity and role database 122 in messaging service 604A to associate the selected identity and role data 644 and 646 with the user account and corresponding network address of the MECD 640. The MECD 640 receives a notification message from the messaging service 604A to indicate the addition of a new identity or role, or the removal of an existing identity or role for the MECD. In some embodiments, when the MECD 640 receives a notification message corresponding to a new role or identity, the MECD 640 retrieves a history of previous communication messages that correspond to the role or identity. For example, the MECD 640 retrieves a backlog of communication messages corresponding to the role A1 in the role-identity data 644 from the online data storage service 628A in response to receiving a notification message that the MECD has the role A1.

In the communication system 600, the messaging systems 602A-602C depict messaging systems that are operated by different organizational entities that communicate with a single MECD corresponding to a single user. For example, some doctors and other medical professionals work with multiple healthcare facilities. In the embodiment of FIG. 6, three different healthcare facilities operate the messaging systems 602A-602C independently. The user is a doctor or other professional who sends and receives messages with each of the messaging systems 602A-602C using a single MECD 640 that is configured to present notifications and communication messages from each of the messaging systems 602A-602C with a unified user interface that only requires execution of a single software application in the MECD 640 to communicate with each of the messaging systems 602A-602C using the corresponding identities 652-656 and roles specified by the role-identity relationships 644-650. Thus, the system 600 enables the user to interact with multiple communication systems without the need to use multiple MECDs or to use multiple software applications to interact with the independent communication systems 602A-602C. The MECD 640 receives notification messages and communication messages that are associated with one or more identities and roles that are assigned to the user and the MECD 640 for the user.

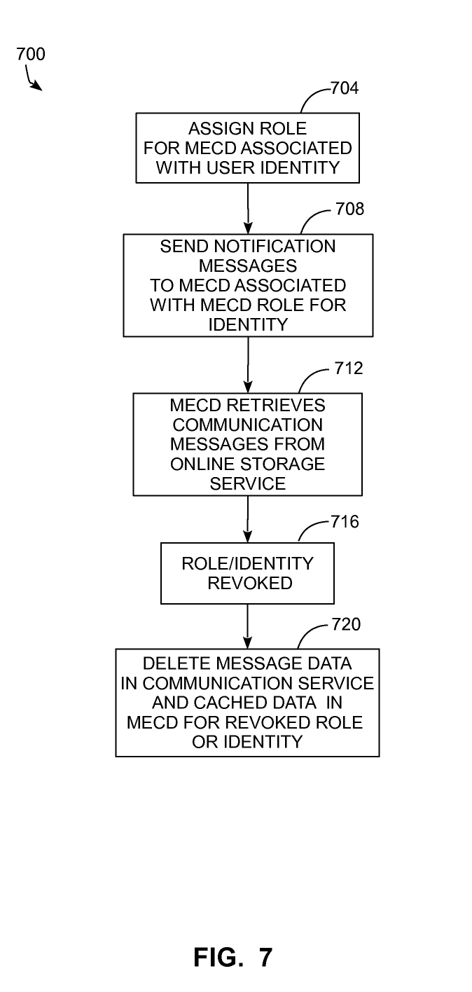

In the system 600, an MECD is depicted as having one or more identities and roles that are optionally associated with one or more separate messaging systems. FIG. 7 depicts a process 700 for managing identities and roles that are associated with an MECD. In the discussion below, a reference to the process performing a function or action refers to a controller executing programmed instructions stored in a memory to operate one or more components to perform the function or action. Process 700 is described with reference to the system 100 of FIG. 1 and the system 600 of FIG. 6 for illustrative purposes.

Process 700 begins with assignment of a role in relation to an identity for an MECD that is associated with a user account (block 704). In the embodiment of the system 100, the administrative terminal 132 presents a user interface display that includes a listing of identities and roles in the identity and role database 122. The identities are generated during an enrollment process for a registered user of the communication system. The identities and roles are associated with MECD network addresses and associated user information in the recipient database 112. The administrator assigns a selected role for an identity of a selected user account. As described above, the administrator operationally assigns multiple roles to a single identity, and multiple identities for different user accounts are optionally associated with a single role.

Process 700 continues as the messaging service sends one or more notification messages to the MECD associated with the identity of a user who is assigned to the role (block 708). For example, in the communication system 600, the messaging service 604A sends a notification message to the MECD 640 informing the MECD that the role “A2” is assigned to the identity “A” in the MECD 640, as depicted in the role-identity data 646. In one embodiment, the MECD 640 sends a receipt message to the messaging service 604A to acknowledge that the MECD 640 has acquired the role and identity relationship. The initial notification message optionally includes credential information that enables the MECD 640 to receive additional notification messages and retrieve communication messages that are directed to the role “A2” 646 from the online data storage service 628A.

The MECD 640 retrieves communication messages that are directed to identity and role data 646 from the online data storage service 628A (block 712). While the MECD 640 remains assigned to the designated identity and role, the MECD continues to receive additional notification messages from the messaging service 604A that identify communication messages for the designated role-identity relationship 646. The MECD 640 retrieves the communication messages from the online data storage services 628A and sends receipt messages to acknowledge the communication messages and to provide feedback from the user of the MECD 640 to the messaging service 604.

The messaging services 602A-602C and the MECD 640 send and receive messages for each of the role-identity relationships 644-650 in a similar manner as described above in the processes 400 and 500. To send a communication message to a role instead of to the identities corresponding to an individual recipient address or group of recipient addresses, a sending device selects a displayed name of the role as a recipient of the communication message. For example, the role “A2” 646 includes a human readable title of “ON-CALL PHYSICIAN.” A user of the messaging system 602A selects the recipient of a communication message as the ON-CALL PHYSICIAN role, without having to enter the default recipient addresses for members of the ON-CALL PHYSICIAN role. The message service 604A identifies the appropriate recipient addresses in the recipient database that are associated with the role and corresponding identity in the identity and role database 122, and the messaging service 604 sends notification messages to the MECD 640 and other MECDs that are associated with the role.

During process 700, one or more of the identities and roles that are associated with a user of the MECD can be revoked (block 716). For example, in the communication system 600, an administrator uses the administrative terminal 632A to remove the association between either or both of the roles “A1” and “A2” and the identity “A” in the identity and role database 122. Administrators in the messaging systems 602B and 602C similarly configure the message services 604B and 604C to revoke the role-identity associations “B1”-“B” and “C1”-“C” in the role-identity data sets 648 and 650, respectively. The relationship between the role and an identity may be revoked for several reasons. For example, if a user with the MECD 640 works at the facility corresponding to the messaging system 602B for a limited time, then the administrator of the messaging system 602B revokes the role “B1” for the identity “B” when the user leaves employment of the facility. Additionally, the administrator optionally deletes the entire identity “B” from the system to prevent the user from sending or receiving any communication messages using the communication system 602B.

In another configuration, a role is assigned to and revoked from an identity on a regular basis. For example, in the messaging system 602A, the user of the MECD 640 is assigned to the “ON-CALL PHYSICIAN,” role “A2” associated with the identity “A” in the role-identity data 646 during a shift at the facility when the user is available on-call to receive messages. At the end of the shift, the messaging service 604A revokes the role-identity relationship 646 for the MECD 640 and assigns the role to identities of different MECD users who are the on-call physicians for the next shift. In one embodiment, and administrator configures the messaging service 604A to assign and revoke role-identity relationships on a regular basis in accordance with predetermined schedules of the users who are associated with the MECDs. After a role is revoked from an identity, the MECD of the user with the identity, such as the MECD 640, does not receive additional notification messages corresponding to communication messages that are sent to the role. After an identity is revoked, the messaging service 604A sends no further notification messages to the MECD 640 when a new communication message is sent to the revoked identity, and the messaging service 604A does not forward communication messages to the online data service 628A if the recipient address corresponds to a revoked identity.

During process 700, the MECD deletes any data associated with an identity or a previously assigned role from the data storage memory 240 in response to revocation of the identity or role in the corresponding messaging system (block 720). In one embodiment, the messaging service sends a command message to the MECD with an instruction to delete the message data and other data associated with an identity or role. For example, when an administrator revokes the role-identity relationship 646 in the messaging system 602A, the messaging service 604A sends a command message to the MECD 640 indicating the revocation of the identity 646. The messaging application in the MECD 640 deletes any stored data that are associated with the role-identity relationship 646 and the MECD 640 optionally sends a confirmation message to the messaging service 604A to confirm deletion of the identity data. Similarly, if an identity such as the identity 652 is revoked, the MECD 640 deletes data associated with the identity and data associated with any roles with relationships to the identity, including communication messages, authentication data, and address book data. While the MECD 640 deletes the identity or role-identity relationship data, the corresponding messaging service, such as the messaging service 604A, optionally archives the communication messages for later review. For example, in some industries, such as the medical industry, the messaging service 604A archives communication messages in a manner that complies with regulatory requirements for the purpose of secure medical data retention. The communication messages are deleted from the MECD 640 after use, however, to protect the privacy of patients who are referenced in the communication messages.

In the illustrative embodiment of FIG. 7, the process 700 describes the management of an identity for a single MECD. As described above in FIG. 6, a single messaging system assigns and revokes one or more identities and role-identity relationships for an MECD. Additionally, multiple messaging systems optionally assign and revoke identities and role-identity relationships from a single MECD. When a messaging system revokes an identity or role-identity relationship from the MECD, the message data associated with the identity or role-identity are deleted from the MECD. When one identity is revoked from the MECD, the MECD still enables the user to send and receive communication messages that are associated with other identities for the user, however.

While the system and method for device control have been illustrated by the description of exemplary processes and system components, and while the various processes and components have been described in considerable detail, applicant does not intend to restrict or in any limit the scope of the appended claims to such detail. For example, while the aforementioned embodiments are directed for use in conjunction with healthcare services for illustrative purposes, the embodiments described above and variations thereof can also be used in any field that employs messaging between MECDs. Additional advantages and modifications will also readily appear to those skilled in the art. Therefore, the system and method described above in their broadest aspects are not limited to the specific details, implementations, or illustrative examples shown and described. Accordingly, departures may be made from such details without departing from the spirit or scope of applicant's disclosed system and method.

We claim:

1. An mobile electronic communication device comprising:
a housing;
a wireless transceiver supported by the housing and configured to send and receive data with a wireless communication network;
an output device supported by the housing;
a memory supported by the housing and configured to store programmed instructions; and
a controller supported by the housing and operatively connected to the memory, the output device, and the wireless transceiver, the controller being configured to:
execute programmed instructions for a messaging program stored in the memory;
suspend execution of the programmed instructions for the messaging program;
resume execution of the programmed instructions for the messaging program to retrieve a communication message from an online data storage service with the wireless transceiver in response to the wireless transceiver receiving a notification message from a messaging service, the notification message including an identifier corresponding to the messaging program; and
generate an output corresponding to the communication message with the output device.

2. The mobile electronic communication device of claim 1, the notification message being a session initiation protocol (SIP) message.

3. The mobile electronic communication device of claim 1, the controller being further configured to:
send a delivery receipt message to the messaging service with the wireless transceiver in response to retrieving the communication message.

4. The mobile electronic communication device of claim 1, the online data storage service being a message queue service.

5. The mobile electronic communication device of claim 1, the online data storage service being an electronic mail server.

6. The mobile electronic communication device of claim 1, the online data storage service being an instant messaging server.

7. The mobile electronic communication device of claim 1 further comprising:
an input device supported by the housing and operatively connected to the controller; and
the controller being further configured to:
generate a prompt for user input with the output device in response to retrieving the communication message;
generate a response message with reference to data generated by the input device; and
send the response message to the messaging service with the wireless transceiver.

8. The mobile electronic communication device of claim 1, the messaging service being different than the online data storage service.

9. The mobile electronic communication device of claim 1, the controller being further configured to:
operate in a low power mode while execution of the messaging program is suspended.

10. The mobile electronic communication device of claim 9, the controller being further configured to:
execute programmed instructions for another program that are stored in the memory to listen for reception of the notification message with the wireless transceiver, the other program being executed while the processor operates in the low power mode.

11. The mobile electronic communication device of claim 1, the controller being further configured to:
execute programmed instructions for another program stored in the memory while the messaging program is suspended, the other program generating an output with the output device.

12. A network communication system comprising:
an online data storage service;
a mobile electronic communication device communicatively coupled to the data storage service through a data network; and
a server executing programmed instructions stored in a memory operatively connected to the server, the server being communicatively connected to the online data storage service and the mobile electronic communication device through the data network, the server being configured to:
receive a first communication message intended for delivery to the mobile electronic communication device;
store the first communication message in the online data storage service; and
send a first notification message to the mobile electronic communication device in response to the first communication message being stored in the online data storage service.

13. The network communication system of claim 12, the first notification message being sent with a session initiation protocol (SIP) to enable the mobile communication device to receive the first notification message while operating in a low-power mode, and to execute programmed instructions stored in a memory to retrieve the first communication message from the online data storage service.

14. The network communication system of claim 12, the server being configured to receive the first communication message from another mobile electronic communication device.

15. The network communication system of claim 12, the server being configured to send the first communication message through the data network to the online data storage service to store the first communication message.

16. The network communication system of claim 12, the server being further configured to:
receive a delivery receipt message from the mobile electronic communication device that indicates the mobile electronic communication device has retrieved the first communication message; and
store data corresponding to the delivery receipt message in a response database in association with the first communication message.

17. The communication system of claim 16, the server being further configured to:
transmit a second notification message to the mobile electronic communication device after expiration of a first predetermined timeout from the transmission of the first notification message in response to a failure to receive the delivery receipt message from the mobile electronic communication device.

18. The communication system of claim 17, the server being further configured to:
transmit a third notification message to the mobile electronic communication device after expiration of a second predetermined timeout from the transmission of the second notification message in response to a failure to receive the delivery receipt message from the mobile electronic communication device, the second predetermined timeout being shorter than the first predetermined timeout.

19. The network communication system of claim 12, the server being further configured to:
receive a response message from the mobile electronic communication device, the response message being sent in response to a user of the mobile electronic communication device acknowledging receipt of the first communication message; and
store data corresponding to the response message in a response database in association with the first communication message.

20. The network communication system of claim 12 further comprising:
a plurality of mobile electronic communication devices communicatively coupled to the data storage service through the data network; and
the server further comprising:
a database storing data corresponding to a role and an association between the role and an identity corresponding to a network address of a first one of the plurality of mobile electronic communication devices; and
the server being further configured to:
receive a second communication message intended for delivery to the role, the second communication message not including identifying information corresponding to the first one of the plurality of mobile electronic communication devices;
store the second communication message in the online data storage service;
identify the network address of the first one of the plurality of mobile electronic communication devices with reference to the database; and
send a notification message to the first one of the plurality of mobile electronic communication devices with reference to the identified network address of the first one of the plurality of mobile electronic communication devices in response to the second communication message being stored in the online data storage service.

21. The system of claim 20, the server being further configured to:
remove the data corresponding to the association between the role and the identity from the database to revoke the role for the identity associated with the first one of the plurality of mobile electronic communication devices; and
send a message to the first one of the plurality of mobile electronic communication devices indicating revocation of the role.

22. The system of claim 21, the first mobile electronic communication device further comprising:
a memory configured to store the first communication message; and
a processor operatively connected to the memory, the processor being configured to:
delete the first communication message from the memory in response to receiving the message indicating revocation of the role from the server.

23. The system of claim 21, the server being further configured to:
store data corresponding to another association between the role and another identity associated with a network address of a second one of the plurality of mobile electronic communication devices in the database;
receive a third communication message intended for delivery to the role, the third communication message not including identifying information corresponding to the second one of the plurality of mobile electronic communication devices;
store the third communication message in the online data storage service;
identify the network address of the second one of the plurality of mobile electronic communication devices with reference to the database; and
send a notification message to the second one of the plurality of mobile electronic communication devices with reference to the identified network address of the second one of the plurality of mobile electronic communication devices in response to the other communication message being stored in the online data storage service.
